(19) United States
(12) Patent Application Publication
(10) Pub. No.: US 2003/0036313 A1
(43) Pub. Date: Feb. 20, 2003

(54) Plug connector with adapter

(75) Inventors: Hans-Peter Bollin, Lubbecke (DE); Hartmut Schwettmann, Rahden (DE); Uwe Sundermeier, Espelkamp (DE)

Correspondence Address: Norman P. Soloway, HAYES SOLOWAY, P.C., 130 W. Cushing Street, Tucson, AZ, 85701, US

(73) Assignee: HARTING KGaA

(21) Appl. No.: 10/215,217

(22) Filed: Aug. 8, 2002

(30) Foreign Application Priority Data
Aug. 14, 2001 (DE) 201 13 501.9

(51) Int. Cl. H01R 25/00

(52) U.S. Cl. 439/638

(57) ABSTRACT

A plug connector comprises a first plug connector part, a female plug that is received in said first plug connector part, a second plug connector part and an adapter that is received in said second plug connector part.

### TECHNICAL FIELD

The invention relates to a plug connection between a plug known from office equipment, in particular an RJ45 type plug, and to a female plug, in particular an RJ45 type female plug.

### BACKGROUND OF THE INVENTION

From office equipment there are known network plugs which serve for e.g. connecting computers to networks, such as RJ45 type plugs. Such plugs are well-tried and low-cost components. There are also known industrial plug connectors by means of which a reliable electrical connection is possible also in environments in which there are made high demands on the mechanical strength, the resistance against environmental conditions, the tightness against dust and fluids as well as on the machinability with conventional industrial tools.

More recently, classic network technologies from the world of office equipment push their way into the industrial environment. This is supported by the availability of low-cost and well-tried hardware and software components. Due to the fact that networks and bus systems growing together in the control/power field, there is a need for the forwarding of network signals in the industrial field. The system cables designed for the office environment are, however, not suitable for the industrial field, because they do not fulfill the requirements on a plug connection in terms of mechanical strength as well as tightness.

It is therefore the object of the invention to make it possible to use the well-tried and low-cost office network plugs also in the industrial field.

### BRIEF SUMMARY OF THE INVENTION

According to the invention, a plug connector comprises a first plug connector part, a female plug that is received in the first plug connector part, a second plug connector part and an adapter that is received in the second plug connector part. It is by means of the adapter that the plug, in particular an RJ45 type plug, can be received in the second plug connector part. On assembling the first and second plug connector parts, the RJ45 type plug is plugged into the female plug received in the first plug connector part, and the first and second plug connector parts ensure the mechanical strength as well the sealing.

Advantageous designs of the invention will be apparent from the subclaims.

### BRIEF DESCRIPTION OF THE DRAWINGS

FIG. 1 shows in a perspective, partial sectional view a first plug connector part including a female plug;

FIG. 2 shows in a perspective, partial sectional view a second plug connector part including an adapter; and

FIG. 3 shows in a perspective view the plug connector consisting of the first and second plug connector parts.

### DETAILED DESCRIPTION OF THE PREFERRED EMBODIMENT

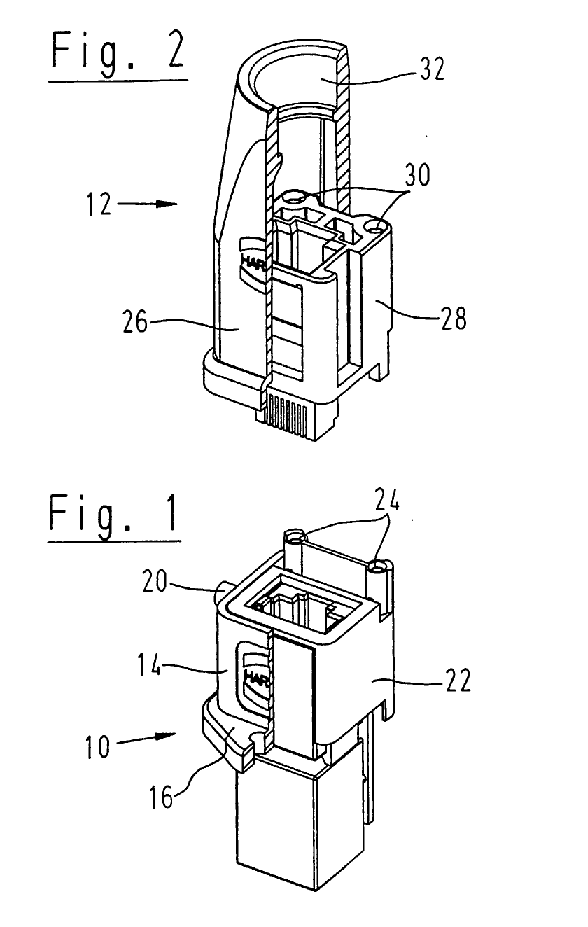

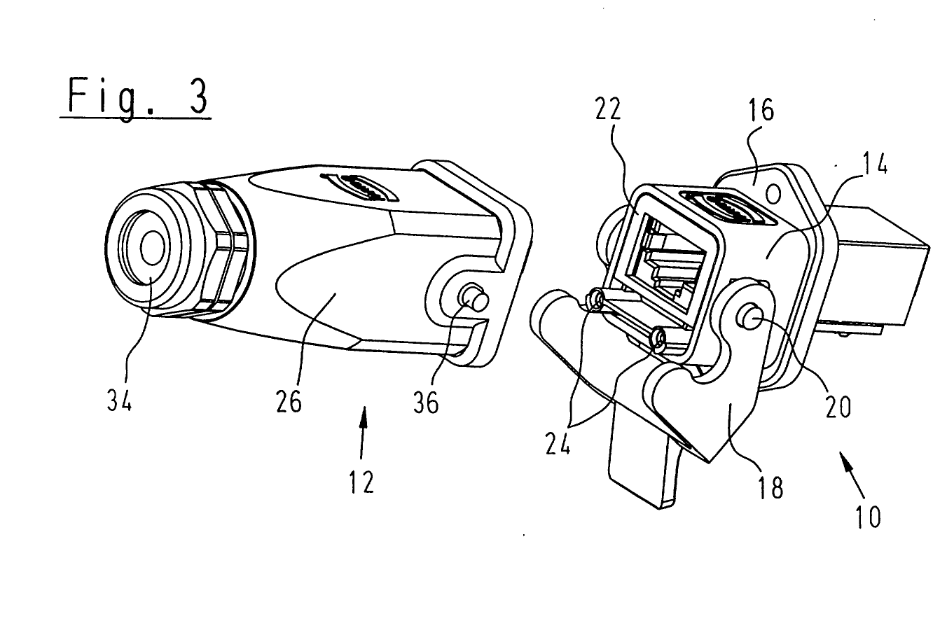

In FIG. 3 there is to be seen a plug connector that consists of a first plug connector part 10 (see also FIG. 1) and a second plug connector part 12 (see also FIG. 2).

The first plug connector part has a body 14 including a mounting flange 16. There is further provided a locking bracket 18 (see FIG. 3) which is arranged on two supporting pins 20.

Received in the interior of the body 14 is a female plug 22 which is configured, in particular, for receiving an RJ45 type plug. Moreover, the female plug is provided with two receiving openings 24 with one power contact each being arranged therein.

The second plug connector part has a body 26 with an adapter 28 being arranged therein. The adapter 28 is designed such that it can receive an RJ45 type plug in such a manner that the latter projects beyond that end face of the adapter 28 which is associated to the female plug 22 of the second plug connector part. The adapter 28 is further provided with two receiving openings 30 in which power contacts are arranged that cooperate with the power contacts of the first plug connector part.

Finally, the body 26 of the second plug connector part 12 is provided with a receiving sleeve 32 for a screwed cable gland 34 (see FIG. 3). The body 26 of the second plug connector part further comprises two latching pins 36 on its outer surface, which can be engaged by the locking bracket 18 of the first plug connector part 10.

For anchoring the female plug 22 in the body 14 of the first plug connector part and for anchoring the adapter 28 in the body 26 of the second plug connector part, there may be used latching connections which consist of a latching tab on the body concerned and of a latching opening in the female plug and adapter, respectively, or vice versa.

On assembling, the (not shown) prefabricated RJ45 type plug is inserted into the adapter 28 such that it latches in place there. Next, the screwed cable gland 34 is applied to the cable attached to the plug and is screwed in the receiving sleeve 32, so that a sealing is obtained. Subsequently, the second plug connector part including the RJ45 type plug can be placed on the first plug connector part, the RJ45 type plug engaging into the female plug 22. The first and second plug connector parts 10, 12 can be mechanically fixed to each other in a reliable fashion. A sealing (not shown) which is provided on the first or second plug connector part ensures the sealing.

The power contacts can be used for the power supply of a connected equipment or for the switchover of bus signals. The first plug connector part 10 may be arranged on a printed circuit board. The power contacts arranged in the receiving openings 24 may be contacted via the printed circuit board or through separate cables. In case the plug received in the second plug connector part is shielded, shielding is continued via the cable shielding braid to the shielded office plug connector and is then continued to the printed circuit board.

1. A plug connector comprising a first plug connector part, a female plug that is received in said first plug connector part, a second plug connector part and an adapter that is received in said second plug connector part.

2. The plug connector according to claim 1, wherein said adapter is configured for receiving an RJ45 type plug and said female plug is an RJ45 type female plug.

3. The plug connector according to claim 1, wherein two power contacts are provided that are arranged at the side of said adapter.

4. The plug connector according to claim 1, wherein said second plug connector part is provided with a screwed cable gland.

5. The plug connector according to claim 1, wherein a seal is provided between said first and second plug connector parts.

6. The plug connector according to claim 1, wherein a locking bracket is provided, by means of which said first and second plug connector parts can be mechanically locked to each other.

7. The plug connector according to claim 1, wherein said first plug connector part is provided with a mounting flange.
